(19) United States
(12) Patent Application Publication
(10) Pub. No.: US 2025/0018640 A1
(43) Pub. Date: Jan. 16, 2025

(54) A POLYMER MATERIAL FOR USE IN A 3D PRINTING PROCESS

(71) Applicant: SIKA TECHNOLOGY AG, Baar (CH)

(72) Inventors: Peter HÜBSCHER, Obernau (CH); Patrick HUEPPI, Stalden (CH); Roy Z'ROTZ, Ebikon (CH); Wilfried CARL, Kreuzlingen (CH)

(73) Assignee: SIKA TECHNOLOGY AG, Baar (CH)

(21) Appl. No.: 18/690,388

(22) PCT Filed: Oct. 13, 2022
(86) PCT No.: PCT/EP2022/078534

§ 371 Date: Mar. 8, 2024

(30) Foreign Application Priority Data
Oct. 14, 2021 (EP) 21202768.4

(51) Int. Cl. B29C 64/10; B29K 105/12; B33Y 10/00; B33Y 70/00; B33Y 80/00; C08F 10/02; C08K 7/02

(52) U.S. Cl. CPC B29C 64/10; B33Y 10/00; B33Y 70/00; C08F 10/02; C08K 7/02; B29K 2023/06; B29K 2105/122; B29K 2995/0082; B33Y 80/00; C08K 2201/003

(57) ABSTRACT

A polymer material in manufacture of 3D articles by means of additive manufacturing, the polymer material including: at least one polyethylene having a density at 23° C. determined according to EN ISO 1183-1:2019 standard of at least 0.930 kg/m3 and a crystallinity determined according to EN ISO 11357-3:2018 standard of at least 50 wt.-%, at least one solid filler, and at least one nucleating agent, wherein the at least one solid filler is a fibrous filler having a volume-based mean aspect ratio (length/diameter) of 3-60.

### TECHNICAL FIELD

The invention relates to polymer materials that are suitable for manufacturing of three-dimensional articles by means of additive manufacturing technology. Particularly, the invention relates to use of polyethylene-based polymer blends in a material extrusion-based 3D-printing process.

### BACKGROUND ART

According to ISO 52900-2015 standard, the term “additive manufacturing” refers to technologies that use successive layers of material to create a three-dimensional (3D) objects. In an additive manufacturing process, the material is deposited, applied, or solidified under computer control based on a digital model of the 3D object to be produced, to create the 3D article. The digital model of the 3D article can be created, for example, by using a CAD software or a 3D object scanner.

Additive manufacturing processes are also referred to using terms such as “generative manufacturing methods” or “3D printing”. The term “3D printing” was originally used for an ink jet printing based AM process created by Massachusetts Institute of Technology (MIT) during the 1990s. Compared to conventional technologies, which are based on object creation through either molding/casting or subtracting/machining material from a raw object, additive manufacturing technologies follow a fundamentally different approach for manufacturing. Particularly, it is possible to change the design for each object, without increasing the manufacturing costs, offering tailor made solutions for a broad range of products.

Generally, in an additive manufacturing process, a 3D article is manufactured using a shapeless material (e.g. liquids, powders, granules, pastes, etc.) and/or a shape-neutral material (e.g. bands, wires, filaments) that is subjected to chemical and/or physical processes (e.g. melting, polymerization, sintering, curing or hardening). The main categories of additive manufacturing technologies include VAT photopolymerization, material extrusion, material jetting, binder jetting, powder bed fusion, direct energy deposition, and sheet lamination techniques. Widely used additive manufacturing technologies based on material extrusion include fused filament fabrication (FFF) and fused particle fabrication (FPF).

In a fused filament fabrication (FFF) process, also known as fused deposition modeling (FDM), a 3D article is produced based on a digital model of the 3D article using a polymer material in form of a filament. In a FFF process, a polymer filament is fed into a moving printer extrusion head, heated past its glass transition temperature or melting temperature, and then deposited through a heated nozzle of the printer extrusion head as series of layers in a continuous manner. After the deposition, the layer of polymer material solidifies and fuses with the already deposited layers. A fused particle fabrication (FPF), also known as fused granular fabrication (FGF), differs from a FFF process only in that the polymer material is provided in form of particles, such as granules or pellets, instead of a filament.

Commonly used thermoplastic materials for fused filament fabrication and fused particle fabrication processes include particularly acrylonitrile butadiene styrene (ABS), polylactic acid (PLA), polycarbonate (PC), and polyamide. For example, a published patent application EP 3 476 898 A1 discloses a thermoplastic polymer composition for use in 3D printing comprising at least 25 wt.-% of an amorphous polyamide, at least 5 wt.-% of a crystalline or semicrystalline thermoplastic polymer, and optionally at least 1 wt.-% of a filler.

High density polyethylene (HDPE) is a commonly used material in many commercial applications due to its high strength and low costs. However, the use HDPE as a material for 3D printing, especially in material extrusion 3D printing, is known to be notoriously difficult due to the inherent shrinkage of the polymer material upon cooling and the low adhesion to the building plate. Consequently, HDPE is generally not a preferred material for 3D printing. However, in some industrial applications, such as pipes used for carrying potable water, wastewater, slurries, chemicals, hazardous wastes, or compressed gases, a minimum required strength (MRS) according to ISO/TR 9080 of at least 10 MPa is required. In these applications, only polyethylene with a particularly high strength, such as PE100, can be used. The high density and crystallinity of the PE100 makes it extremely difficult to use in 3D printing, mainly due to high shrinkage of the material upon cooling.

The challenges in using high strength polyethylene in 3D printing can be mitigated at least to some extent by careful control of process parameters and by blending of other polymers with the polyethylene material. Another published patent application WO 2020/028013 A1 discloses a method for fused filament fabrication (FFF) comprising employing a thermoplastic blend comprised of high density polyethylene (HDPE) and a second polymer, wherein the weight ratio of the amount of the high density polyethylene to the amount of the second thermoplastic polymer is in the range from 1.5:1 to 20:1. Mixing of the HDPE with a second polymer, such as low density polyethylene (LDPE), however, strongly affects the mechanical properties of the 3D printed article.

There is thus a need for a high-strength polyethylene-based material, which is suitable for use as a 3D printing material, particularly for 3D printers operating with fused filament fabrication (FFF) or fused particle fabrication (FPF) techniques.

### BRIEF DESCRIPTION OF DRAWINGS

FIG. 1 shows how a curvature radius (R) is determined for a vertical wall of a 3D printed cube based on height (h) of a segment and a chord length (r) of a secant.

FIG. 2 shows how a dumbbell shaped sample is cut from the walls of a 3D printed cube in horizontal (x, machine) and vertical (z, interlayer) directions.

### DISCLOSURE OF THE INVENTION

It is an object of the present invention to provide a high strength polyethylene-based material, which is suitable for use in providing three-dimensional articles using material extrusion based 3D-printing techniques, particularly fused filament fabrication (FFF) or fused particle fabrication (FPF) processes.

Surprisingly, it has been found out that the object can be achieved by the features of claim 1.

Especially, it has been found out that the polymer material as defined in claim 1 enables fast and cost-efficient production of customized 3D articles with complex shapes using material extrusion based 3D printing techniques, wherein the 3D articles have a minimum strength (MRS) according to ISO/TR 9080 of at least 10 MPa.

One of the advantages of the polymer material of the present invention is that the suitability of a basic polyethylene-based material for 3D printing applications can be improved without having a negative impact on other properties of the polymer material, particularly the strength of the material. Furthermore, the additional constituents added to the basic polyethylene material do not significantly increase the total costs of the polymer material.

Further subjects of the present invention are defined in further independent claims. Preferred embodiments are outlined throughout the description and the dependent claims.

### DETAILED DESCRIPTION

The subject of the present invention is use of a polymer material for the manufacture of 3D articles by an additive manufacturing process, the polymer material comprising:
a) At least one polyethylene PE having a density at 23° C. determined according to EN ISO 1183-1:2019 standard of at least 0.930 kg/m³ and a crystallinity determined according to EN ISO 11357-3:2018 standard of at least 50 wt.-%,
b) At least one solid filler F, and
c) Optionally at least one nucleating agent N,
   wherein the at least one solid filler F is a fibrous filler having a volume-based mean aspect ratio (length/diameter) of 3-60, preferably 4-50.

The abbreviation “3D” is used throughout the present disclosure for the term “three-dimensional.

The term “polymer” refers to a collective of chemically uniform macromolecules produced by a polyreaction (polymerization, polyaddition, polycondensation) of monomers of same of different type where the macromolecules differ with respect to their degree of polymerization, molecular weight, and chain length. The term also encompasses derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “molecular weight” refers to the molar mass (g/mol) of a molecule or a part of a molecule, also referred to as “moiety”. The term “average molecular weight” refers to number average molecular weight (Mₙ) or to weight average molecular weight (M_{w}) of an oligomeric or polymeric mixture of molecules or moieties. The molecular weight may be determined by gel permeation chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “softening point” refers to a temperature at which compound softens in a rubber-like state, or a temperature at which the crystalline portion within the compound melts. The softening point is preferably determined by Ring and Ball measurement conducted according to DIN EN 1238:2011 standard.

The term “melting temperature” or “melting point” refers to a temperature at which a material undergoes transition from the solid to the liquid state. The melting temperature (Tₘ) is preferably determined by differential scanning calorimetry (DSC) according to ISO 11357-3 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) refers to the temperature above which temperature a polymer component becomes soft and pliable, and below which it becomes hard and glassy. The glass transition temperature (T_{g}) is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one thermoplastic polymer TP” refers to the sum of the individual amounts of all thermoplastic polymers TP contained in the composition. Furthermore, in case the composition comprises 20 wt.-% of at least one thermoplastic polymer TP, the sum of the amounts of all thermoplastic polymers TP contained in the composition equals 20 wt.-%.

The term “normal room temperature” designates a temperature of 23° C.

The polymer material for use in additive manufacturing process comprises at least one polyethylene having a density at 23° C. determined according to EN ISO 1183-1:2019 standard of at least 0.930 kg/m³, preferably at least 0.935 kg/m³, more preferably at least 0.940 kg/m³, even more preferably at least 0.950 kg/m³ and a crystallinity determined according to EN ISO 11357-3:2018 standard of at least 50 wt.-%, preferably at least 60 wt.-%, more preferably at least 70 wt.-%.

The crystallinity of the polyethylene PE can be determined according to formula (I):

$$D = \frac{Δ {H}_{f}}{Δ {H}_{f , 100}} \cdot 100 \%$$

wherein
D is the crystallinity of the polyethylene PE in %,
ΔH, is the enthalpy of fusion of the polyethylene PE in J/g determined according to
EN ISO 11357-3:2018 standard, and
ΔH_{f,100} is the enthalpy of fusion of a polyethylene having a crystallinity of 100% in J/g, i.e., 293 J/g.

According to one or more embodiments, the additive manufacturing process is a fused filament fabrication or a fused particle fabrication process.

In a fused filament fabrication (FFF) process, a polymer filament is fed into a moving printer extrusion head, heated past its glass transition temperature (T_{g}) or melting temperature (Tₘ), and then deposited through a heated nozzle of the printer extrusion head as series of layers in a continuous manner. After the deposition, the layer of polymer material solidifies and fuses with the already deposited layers. The printer extrusion head is moved under computer control to define the printed shape based on control data calculated from the digital model of the 3D article.

A fused particle fabrication (FPF), also known as fused granular fabrication (FGF), differs from a FFF process only in that the polymer material is provided in form of particles, such as granules or pellets, instead of a filament.

Suitable compounds for use as the at least one polyethylene PE include ethylene homopolymers and ethylene copolymers.

Preferably, the at least one polyethylene PE has a melt flow index (190° C./2.16 kg) determined according to ISO 1133-1:2011 standard of at least 1 g/10 min, more preferably at least 2.5 g/10 min, even more preferably at least 3.5 g/10 min. According to one or more embodiments, the at least one polyethylene PE has a melt flow index (190° C./2.16 kg) determined according to ISO 1133-1:2011 standard of 1-50 g/10 min, preferably 2-25 g/10 min, more preferably 3-15 g/10 min.

Preferably, the at least one polyethylene PE has a flexural modulus at 23° C. determined according to ISO 178:2019 standard of at least 450 MPa, more preferably at least 550 MPa, even more preferably at least 650 MPa and/or a melting temperature determined by differential scanning calorimetry (DSC) according to ISO 11357-3:2018 standard using a heating rate of 2° C./min of at or above 105° C., more preferably at or above 110° C., even more preferably at or above 115° C.

According to one or more embodiments, the at least one polyethylene PE has a flexural modulus at 23° C. determined according to ISO 178:2019 standard of 400-1500 MPa, preferably 500-1350 MPa, more preferably 600-1250 MPa.

Preferably, the at least one polyethylene PE comprises at least 50 wt.-%, more preferably at least 65 wt.-%, even more preferably at least 75 wt.-%, of the total weight of the polymer material. Generally, the expression “component X comprises Y wt.-% of the total weight of a composition” is understood to mean that the amount of component X makes up Y wt.-% of the total weight of the composition, i.e., the composition comprises Y wt.-% of the component X. According to one or more embodiments, the at least one polyethylene PE comprises 55-97.5 wt.-%, preferably 65-97.5 wt.-%, more preferably 75-96.5 wt.-%, of the total weight of the polymer material.

According to one or more embodiments, the at least one polyethylene PE comprises at least 75 wt.-%, preferably at least 85 wt.-%, more preferably at least 90 wt.-%, even more preferably at least 92.5 wt.-%, still more preferably at least 95 wt.-%, most preferably at least 97.5 wt.-%, of the polymer basis of the polymer material. The “polymer basis” of the polymer material is understood to encompass all polymer compounds of the polymer composition, including the at least one polyethylene PE.

The polymer material further comprises at least solid filler F, which is a fibrous filler having a volume-based mean aspect ratio of 3-60, preferably 4-50, more preferably 4-35, even more preferably 5-25.

The term “fibrous filler” refers in the present disclosure to fibers as well as to needle-shaped fillers, also known as whiskers, which typically have a fiber length of less than 100 μm.

The term “aspect ratio” of a particle refers in the present disclosure to the value obtained by dividing the length (L) by the diameter (D) of the particle. The “length of a particle” refers in the present disclosure to the maximum Feret diameter (X_{Fe,max}), i.e. the longest Feret diameter out of the measured set of Feret diameters. The term “Feret diameter” refers to the distance between two tangents on opposite sides of the particle, parallel to some fixed direction and perpendicular to the measurement direction. The “diameter of a particle” refers in the present disclosure to the minimum Feret diameter (X_{Fe,min}), i.e. the shortest Feret diameter out of the measured set of Feret diameters. The aspect ratio can, therefore, calculated as the ratio of X_{Fe,max} and X_{Fe,min}.

The aspect ratio of a particle can be determined by measuring the length and diameter of the particle using any suitable measurement technique, such as by using dynamic image analysis method conducted according to ISO 13322-2:2006 standard and calculating the aspect ratio from the measured dimensions of the particle as described above. The dimensions of particles are preferably measured with a dry dispersion method, where the particles are dispersed in air, preferably by using air pressure dispersion method. The measurements can be conducted using any type of dynamic image analysis apparatus, such as a Camsizer XT device (trademark of Retsch Technology GmbH).

The term “volume-based mean aspect ratio” refers in the present disclosure to the aspect ratio below which 50% of all particles by volume have a smaller aspect ratio than the value of the mean aspect ratio.

According to one or more embodiments, the at least one solid filler F has a volume-based mean particle diameter D₅₀ of not more than 50 μm, preferably not more than 35 μm, more preferably not more than 25 μm and/or a volume-based mean particle length L₅₀ of at least 5 μm, preferably at least 10 μm, more preferably at least 15 μm, even more preferably at least 20 μm.

The term “volume-based mean diameter D₅₀” refers in the present disclosure to the diameter below which 50% of all particles by volume have a smaller diameter than the of the mean diameter D₅₀. In analogy, the term ““volume-based mean length L₅₀” refers in the present disclosure to the length below which 50% of all particles by volume have a smaller length than the value of the mean length L₅₀.

According to one or more embodiment, the at least one solid filler F has a volume-based mean particle diameter D₅₀ of 1-100 μm, preferably 2.5-50 μm, more preferably 2.5-35 μm, even more preferably 2.5-30 μm, still more preferably 2.5-25 μm and/or a volume-based mean particle length L₅₀ of 10-1000 μm, preferably 15-500 μm, more preferably 20-350 μm, even more preferably 25-250 μm, still more preferably 30-200 μm.

The at least one solid filler F is preferably an inorganic filler.

Suitable inorganic fillers for use as the at least one solid filler F include, for example, glass fibers, aramid fibers, carbon fibers, silicon carbide fibers, alumina fibers, steel fibers, needle-shaped Wollastonite and magnesium oxysulfate whiskers.

Preferably, the at least one solid filler F has a water-solubility of less than 0.1 g/100 g water, more preferably less than 0.05 g/100 g water, even more preferably less than 0.01 g/100 g water, at a temperature of 20° C. The solubility of a compound in water can be measured as the saturation concentration, where adding more compound does not increase the concentration of the solution, i.e. where the excess amount of the substance begins to precipitate. The measurement for water-solubility of a compound in water can be conducted using the standard “shake flask” method as defined in the OECD test guideline 105 (adopted 27 Jul. 1995).

According to one or more embodiments, the at least one solid filler F is selected from the group consisting of glass fibers, carbon fibers, aramid fibers, silicon carbide fiber, alumina fiber, and needle-shaped Wollastonite, preferably from the group consisting of glass fibers and needle-shaped Wollastonite.

Preferably, the at least one solid filler F comprises at least 0.5 wt.-%, preferably at least 1.0 wt.-%, more preferably at least 1.5 wt.-%, even more preferably at least 2.5 wt.-%, of the total weight of the polymer material.

According to one or more embodiments, the at least one solid filler F comprises 5-35 wt.-%, preferably 10-30 wt.-%, more preferably 10-25 wt.-%, even more preferably 10-20 wt.-%, of the total weight of the polymer material.

According to one or more embodiments, the polymer material further comprises at least one nucleating agent N.

Suitable compounds for use as the at least one nucleating agent N include, for example, nanoscale inorganic fillers, such as nanoscale calcium carbonate, titanium dioxide, barium sulfate, silicon dioxide, expanded graphite, multiwall carbon nanotubes, montmorillonite clay, vermiculite nanocomposite mineral, and talc. The term “nanoscale” refers in the present disclosure to solid fillers having a mean particle size d₅₀ of not more than 1 μm, preferably not more than 500 nm, more preferably not more than 250 nm.

The term “particle size” refers in the present disclosure to the area-equivalent spherical diameter of a particle (Xₐᵣₑₐ). The term “mean particle size d₅₀” refers in the present disclosure to a particle size below which 50% of all particles by volume are smaller than the d₅₀ value. The particle size distribution can be determined by sieve analysis according to the method as described in ASTM C136/C136M—2014 standard (“Standard Test Method for Sieve Analysis of Fine and Coarse Aggregates).

Further suitable compounds for us as the at least one nucleating agent N include organic additives, such as sisal fibers, 1,2-cyclohexanedicarboxylic acid, calcium salts, anthracene, potassium hydrogen phthalate, benzoic acid and derivatives thereof, and sodium benzoate and derivatives thereof.

According to one or more embodiments, the at least one nucleating agent N is selected from the group consisting of nanoscale calcium carbonate, titanium dioxide, barium sulfate, silicon dioxide, expanded graphite, montmorillonite clay, talc, multiwall carbon nanotubes, vermiculite nanocomposite minerals, 1,2-cyclohexanedicarboxylic acid, calcium salts, anthracene, potassium hydrogen phthalate, benzoic acid and derivatives thereof, and sodium benzoate and derivatives thereof.

Suitable nucleating agents are commercially available, for example, under the trade name of UltraGuard® Solution from Milliken.

According to one or more embodiments, the at least one nucleating agent N comprises 0.1-10 wt.-%, preferably 0.5-7.5 wt.-%, more preferably 1.5-5 wt.-%, even more preferably 2.5-5 wt.-%, of the total weight of the polymer material

According to one or more embodiments, the polymer material further comprises at least one color pigment CP, preferably selected from the group consisting of titanium dioxide, zinc oxide, zinc sulfide, barium sulphate, iron oxide, mixed metal iron oxide, aluminium powder, and graphite.

Although some of the compounds used in the present invention are characterized as useful for specific functions, it should be understood that the use of these compounds is not limited to their typical functions. For example, it is also possible that the at least one color pigment CP is also capable of acting as a nucleating agent for the polymer components of the polymer material.

Preferably, the at least one color pigment CP has a has a mean particle size d₅₀ of not more than 1000 nm, more preferably not more than 750 μm, even more preferably not more than 500 nm.

According to one or more embodiments, the at least one color pigment CP has a has a median particle size d₅₀ in the range of 50-1000 nm, preferably 75-750 nm, more preferably 100-650 nm, even more preferably 125-500 μm, still more preferably 150-350 μm, most preferably 200-300 nm.

The polymer material may further comprise one or more UV-stabilizers, preferably at least one hindered amine light stabilizer (HALS). These types of compounds are typically added to polymer blends to prevent light-induced polymer degradation. Such UV-stabilizers are needed especially in case the 3D article is used in outdoor applications.

Suitable hindered amine light stabilizers (HALS) include, for example, bis(2,2,6,6-tetramethylpiperidyl)-sebacate; bis-5(1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylenediamine and 4-tert-octylamino-2,6-dichloro-1,3,5-s-triazine; tris-(2,2,6,6-tetramethylpiperidyl)-nitrilotriacetate; tetrakis-(2,2,6,6-tetramethyl-4-piperidyl)-1,2,3,4-butane-tetra-arbonic acid; and 1,1′(1,2-ethanediyl)-bis-(3,3,5,5-tetramethylpiperazinone).

Suitable hindered amine light stabilizers are commercially available, for example, under the trade name of Tinuvin® (from Ciba Specialty Chemicals), such as Tinuvin® 371, Tinuvin® 622, and Tinuvin® 770; under the trade name of Chimassorb® (from Ciba Specialty Chemicals), such as Chimassorb® 119, Chimassorb® 944, Chimassorb® 2020; and under the trade name of Cyasorb® (from Cytec Industries), such as Cyasorb® UV 3346, Cyasorb® UV 3529, Cyasorb® UV 4801, and Cyasorb® UV 4802; and under the trade name of Hostavin® (from Clariant), such as Hostavin N30.

The polymer material may comprise various further additives, such as thermal stabilizers, UV-absorbers, antioxidants, plasticizers, dyes, matting agents, antistatic agents, impact modifiers, biocides, and processing aids such as lubricants, slip agents, antiblock agents, and denest aids. The total amount of these types of further additives is preferably not more than 15 wt.-%, more preferably not more than 10 wt.-%, even more preferably not more than 5 wt.-%, based on the total weight of the polymer material.

Another subject of the present invention is a method for producing a 3D article comprising the following steps:
i) Providing a digital model of the 3D article,
ii) Based on the digital model, printing the inventive polymer material as described above using a 3D printer to form the 3D article.

The 3D printer is preferably a fused filament fabrication or a fused particle fabrication printer.

A “digital model” refers to a digital representation of a real world object, for example of a pipe connector part, that exactly replicates the shape of the object. Typically, the digital model is stored in a computer readable data storage, especially in a data file. The data file format can, for example, be a computer-aided design (CAD) file format or a G-code (also called RS-274) file format.

According to one or more embodiments, step ii) comprises steps of:
ii1) Feeding the polymer material into the 3D printer,
ii2) Heating the polymer material to provide a melted polymer material,
ii3) Depositing the melted polymer material by using a printer extrusion head of the 3D printer in a selected pattern in accordance with the digital model of the 3D article to form the 3D article.

In step ii2) of the method, the polymer material is preferably heated to a temperature, which is above the melting point of the at least one polyethylene PE to obtain the melted polymer material. In case the polymer material comprises multiple different polyethylenes having different melting points, the polymer material is preferably heated to a temperature, which is above the melting point of the polyethylene having the highest melting point.

The movements of the printer extrusion head in step ii3) of the method are controlled according to control data calculated based on the digital model of the 3D article. The digital model of the 3D article is preferably first converted to a STL file to tessellate the 3D shape of the article and to slice it into digital layers. The STL file is transferred to the 3D printer using custom machine software. A control system, such as a computer-aided manufacturing (CAM) software package, is used to generate the control data based on the STL file. The control system can be part of the 3D printer, or it can be part of a separate data processing unit, for example a computer system.

The digital model of the 3D article is preferably obtained by 3D scanning of the 3D article. 3D scanning is a process of analyzing a real-world object, for example a pipe connector, to collect data on its shape. The collected data can then be used to construct the digital model of the object. Thereby, a control system can be used to generate the digital model out of the collected data. The control system can be part of the 3D scanner or it can be part of a separate data processing unit, for example a computer system. It is however also possible to obtain the digital model by measuring all of the lengths and angles of the 3D article by hand and generating the digital model manually using a modelling software. Nevertheless, this is time consuming and more error-prone than 3D scanning.

There are many different 3D scanners available on the market, which can be used for 3D scanning. The scanning of the 3D article is performed with a handheld and/or portable 3D scanner. Handheld and/or portable 3D scanners do not need a complicated installation and allow for a quick and easy scanning of the 3D article to be produced.

Preferably, the 3D scanner is designed for capturing objects from 1 cm to 20 m, especially 20 cm to 10 m, in length.

Especially, the 3D scanner is a non-contact 3D scanner. Such kind of scanners emit some kind of radiation, e.g. light, ultrasound or x-rays, and detect its reflection or radiation passing through the object to be scanned in order to probe the object.

For example, the 3D scanner is a scanner of type “calibry 3d scanner” by the company Thor3d, Varshavskoe Sh. 33, Moscow, Russia.

A further subject of the invention is a 3D article obtained an additive manufacturing process using the polymer material of the present invention.

The additive manufacturing process is preferably a fused filament fabrication or a fused particle fabrication process.

According to one or more embodiments, the article is a pipe or a pipe connector.

### EXAMPLES

The raw materials presented in Table 1 were used in the examples:

TABLE 1

| | | |
|---|---|---|
| Polyethylene PE1 | BorSafe ®TM HE3490-LS-H | Borouge |
| Polyethylene PE2 | Lupolen ® 4021 K RM | LyondellBasell |
| Solid filler F1 | MF 7982 (19/346) | Lanxess |
| Solid filler F2 | Tremin ® 939-300 FST | Quarzwerke GmbH |
| Nucleating agent N | Ultra Gard ® Solution | Milliken |
| | Natural 10036 | |

### Manufacture of Pellets

The pellets for a fused particle fabrication (FPF) process were prepared according to the following procedure.

A portion of the raw materials of the polymer composition were premixed in a tumbler mixer and then fed to a ZSK laboratory twin-extruder (L/D 44) via a gravimetric dosing scale. Another portion of the raw materials was fed directly via gravimetric dosing trolleys into the laboratory extruder. The raw materials were mixed, dispersed, homogenized, and discharged via the holes of perforated extrusion nozzles. The extruded strands were cooled using a water bath and cut into pellets with suitable dimensions. The pellets were then dried in an oven to remove residual moisture.

### 3D Printing Properties of Polymer Compositions

Suitability of the polymer compositions prepared as described above for 3D printing was tested by using the pellets as feed material in a fused particle fabrication process.

3D articles having a form a hollow cube composed of four outer walls having dimensions of 200 mm×200 mm were manufactured from the tested polymer materials with a Yizumi SpaceA 3D printer. Each 3D-printed article was composed of 222 layers.

The 3D printing was conducted using the process parameters as presented in Table 2 below.

TABLE 2

| | |
|---|---|
| Primary layer height [mm] | 0.9 |
| Printed head speed [m/s] | 0.03 |
| Programm speed [%] | 100 |
| Cooling power [%] | 40 |
| Nozzle size [mm] | 2 |
| Extruder rotation speed [rpm] | 40 |
| Feed zone temperature [° C.] | 60 |
| Heating zone temperature 3 [° C.] | 260 |
| Heating zone temperature 2 [° C.] | 280 |
| Heating zone temperature 1 [° C.] | 280 |
| Nozzle temperature [° C.] | 280 |

Suitability of each tested polymer composition for use as feed material for the 3D printing was estimated based on properties of the 3D printed articles in terms of “degree of warping” and tensile strength.

The constituents of the tested polymer compositions and properties of the 3D printed articles are presented in Table 3.

### Degree of Warping

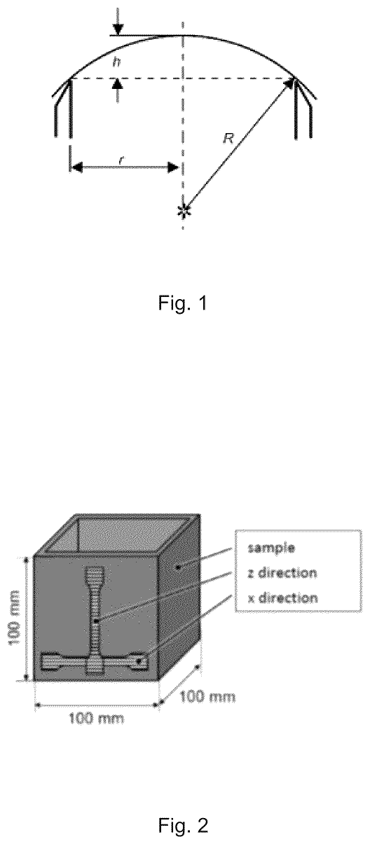

The degree of warping was considered to be represented by the curvature radius (R) of a vertical wall of the 3D printed article (hollow cube). The curvature radius (R) was determined for each 3D printed article using the following formula:

$$R = \frac{( {r}^{2} + {h}^{2} )}{2 h}$$

where h is the height of segment and r is the chord length of a secant having a value of 5 cm as shown in FIG. 1.

### Tensile Strength

Tensile strength of a 3D printed article was measured according to EN 527-1B/5/100 standard using dumbbell shaped samples cut from the walls of the 3D printed articles in horizontal (x, machine) and vertical (z, interlayer) directions as presented in FIG. 2. The values for tensile strengths presented in Table 3 have been obtained as average of three measurements conducted with samples cut from the same 3D printed article.

TABLE 3

| | Ref-1 | Ref-2 | Ex-1 | Ex-2 | Ex-3 | Ex-4 |
|---|---|---|---|---|---|---|
| Compositions [wt.-%] | | | | | | |
| Polyethylene PE1 | 100.00 | 0.00 | 0.00 | 0.00 | 0.00 | 0.00 |
| Polyethylene PE2 | 0.00 | 100.00 | 96.15 | 83.33 | 80.65 | 80.65 |
| Solid filler F1 | 0.00 | 0.00 | 0.00 | 16.67 | 16.13 | 0.00 |
| Solid filler F2 | 0.00 | 0.00 | 0.00 | 0.00 | 0.00 | 16.13 |
| Nucleating agent N | 0.00 | 0.00 | 3.85 | 0.00 | 3.23 | 3.23 |
| Total | 100.00 | 100.00 | 100.00 | 100.00 | 100.00 | 100.00 |
| Properties | | | | | | |
| Curvature radius R [cm] | n/a | 13 | 21 | 25 | 31 | 250 |
| Tensile strength (x) | n/a | n/a | 6.4 | 14.4 | 12.6 | 11.6 |
| [MPa] | | | | | | |
| Tensile strength (z) | n/a | n/a | 8.9 | 12.7 | 18.7 | 17.7 |
| [MPa] | | | | | | |

1. A method of manufacturing a 3D article, comprising manufacturing the 3D article from a polymer material by an additive manufacturing process, the polymer material comprising:
a) at least one polyethylene having a density at 23° C. determined according to EN ISO 1183-1:2019 standard of at least 0.930 kg/m3 and a crystallinity determined according to EN ISO 11357-3:2018 standard of at least 50 wt.-%,
b) at least one solid filler, and
c) optionally at least one nucleating agent,
wherein the at least one solid filler is a fibrous filler having a volume-based mean aspect ratio (length/diameter) of 3-60.

2. The method according to claim 1, wherein the additive manufacturing process is a fused filament fabrication process or a fused particle fabrication process.

3. The method according to claim 1, wherein the at least one polyethylene has a melt flow index (190° C./2.16 kg) determined according to ISO 1133-1:2011 standard of at least 1 g/10 min.

4. The method according to claim 1, wherein the at least one polyethylene has a flexural modulus at 23° C. determined according to ISO 178:2019 standard of at least 450 MPa.

5. The method according to claim 1, wherein the at least one polyethylene comprises at least 50 wt.-% of the total weight of the polymer material.

6. The method according to claim 1, wherein the at least one solid filler has a volume-based mean particle diameter D₅₀ of not more than 50 μm.

7. The method according to claim 1, wherein the at least one solid filler is selected from the group consisting of glass fibers, carbon fibers, aramid fibers, silicon carbide fiber, alumina fiber, and needle-shaped Wollastonite.

8. The method according to claim 1, wherein the at least one solid filler comprises 5-35 wt.-% of the total weight of the polymer material.

9. The method according to claim 1, wherein the at least one nucleating agent is selected from the group consisting of nanoscale calcium carbonate, titanium dioxide, barium sulfate, silicon dioxide, expanded graphite, montmorillonite clay, talc, multiwall carbon nanotubes, vermiculite nanocomposite minerals, 1,2-cyclohexanedicarboxylic acid, calcium salts, anthracene, potassium hydrogen phthalate, benzoic acid and derivatives thereof, and sodium benzoate and derivatives thereof.

10. The method according to claim 1, wherein the at least one nucleating agent comprises 0.1-10 wt.-% of the total weight of the polymer material.

11. The method according to claim 1, wherein the additive manufacturing process includes:
i) providing a digital model of the 3D article,
ii) based on the digital model, printing the polymer material using a 3D printer to form the 3D article.

12. The method according to claim 11, wherein the 3D printer is a fused filament fabrication or a fused particle fabrication printer.

13. A 3D article obtained by the method of claim 1.

14. The 3D article according to claim 13, wherein the additive manufacturing process is a fused filament fabrication or a fused particle fabrication process.

15. The 3D article according to claim 13, wherein the article is a pipe or a pipe connector.
